(19) United States
(12) Patent Application Publication
(10) Pub. No.: US 2026/0356681 A1
(43) Pub. Date: Nov. 12, 2026

(54) METHOD OF RECOVERING LITHIUM CARBONATE FROM LITHIUM-CONTAINING POSITIVE ELECTRODE ACTIVE MATERIAL WASHING LIQUID

(71) Applicant: SAMSUNG SDI CO., LTD., Yongin-si (KR)

(72) Inventor: Seongin PARK, Yongin-si (KR)

(21) Appl. No.: 19/670,210

(22) Filed: May 7, 2026

(30) Foreign Application Priority Data
May 8, 2025 (KR) 10-2025-0060018

(51) Int. Cl. C01D 9/00; H01M 10/54

(52) U.S. Cl. CPC C01D 9/00; H01M 10/54

(57) ABSTRACT

A method of recovering lithium carbonate from a lithium-containing positive electrode active material washing liquid includes adding sodium carbonate to a lithium-containing positive electrode active material washing liquid to form a first precipitation and filtering to obtain a first precipitate including lithium carbonate. Phosphoric acid is added to the remaining washing liquid to form a second precipitation, and filtering to obtain a second precipitate including lithium phosphate; dissolving the second precipitate including the lithium phosphate in an acid to obtain an acid lithium solution; adding a trivalent cation-containing compound to the acid lithium solution and filtering to separate a trivalent cation phosphate and a filtrate; removing the trivalent cation phosphate; and adding sodium carbonate to the filtrate to form a third precipitation to thereby obtain a third precipitate including lithium carbonate.

### CROSS-REFERENCE TO RELATED APPLICATION

This application claims priority to and the benefit of Korean Patent Application No. 10-2025-0060018 filed in the Korean Intellectual Property Office on May 8, 2025, the entire contents of which are incorporated herein by reference.

### BACKGROUND

### 1. Field

The present disclosure relates to a method of producing lithium carbonate from a lithium-containing positive electrode active material washing liquid.

### 2. Description of the Related Art

With the rapid spread of electronic devices that use batteries, such as mobile phones, laptop computers, and electric vehicles, the demand for rechargeable batteries with high energy density and high capacity is rapidly increasing. Accordingly, research and development to improve the performance of rechargeable lithium batteries is actively underway.

Rechargeable lithium batteries include a positive electrode and a negative electrode including an active material capable of intercalating and deintercalating lithium ions and an electrolyte solution. The generate electrical energy through oxidation and reduction reactions when lithium ions are intercalated and deintercalated from the positive electrode and the negative electrode.

As a key raw material for rechargeable lithium batteries, lithium has been steadily increasing in value, and many companies are conducting research on recycling lithium.

### SUMMARY

Some embodiments provide a method of recovering lithium carbonate from a lithium-containing positive electrode active material washing liquid capable of obtaining lithium carbonate in a high yield.

Some example embodiments provide a method of recovering lithium carbonate from a lithium-containing positive electrode active material washing liquid which includes: adding sodium carbonate to a lithium-containing positive electrode active material washing liquid to form a first precipitation, and filtering to obtain a first precipitate including lithium carbonate; adding phosphoric acid to the remaining washing liquid to form a second precipitation, and filtering to obtain a second precipitate including lithium phosphate; dissolving the second precipitate including the lithium phosphate in acid to obtain a lithium phosphate solution, adding a trivalent cation-containing compound to the lithium phosphate solution and filtering to separate a product containing trivalent cation phosphate and a filtrate; and adding sodium carbonate to the filtrate to form a third precipitation, thereby obtaining a third precipitate including lithium carbonate.

A method of recovering lithium carbonate according to some example embodiments may recover lithium carbonate with a high recovery rate through a simple process.

### DETAILED DESCRIPTION

Hereinafter, embodiments of the present disclosure will be described in detail. However, these embodiments are merely examples, the present disclosure is not limited to the disclosed embodiments.

As used herein, when specific definition is not otherwise provided, it will be understood that when an element such as a layer, film, region, or substrate is referred to as being “on” another element, it may be directly on the other element or intervening elements may also be present.

Unless otherwise specified in this specification, what is indicated in the singular may also include the plural. In addition, unless otherwise specified, “A or B” may mean “including A, including B, or including A and B”.

As used herein, “combination thereof” may refer to a mixture, a laminate, a composite, a copolymer, an alloy, a blend, a reaction product, and the like of the constituents.

As used herein, when a definition is not otherwise provided, a particle diameter is an average particle diameter. In addition, the particle diameter may refer to an average particle diameter (D₅₀), which means the diameter of particles having a cumulative volume of 50 vol % in the particle size distribution. The average particle diameter (D₅₀) may be measured by a method well known to those skilled in the art, for example, by a particle size analyzer, or by a transmission electron microscope image, or a scanning electron microscope image. In other embodiments, a dynamic light-scattering measurement device is used to perform a data analysis, and the number of particles is counted for each particle size range. From this, the average particle diameter (D₅₀) value may be easily obtained by calculation. In some embodiments, the average particle diameter may be measured using a laser diffraction method. When measuring by the laser diffraction method, the particles to be measured are dispersed in a dispersion medium and then introduced into a commercially available laser diffraction particle diameter measuring device (e.g., Microtrac MT 3000), and ultrasonic waves of about 28 kHz with an output of 60 W are irradiated to calculate an average particle diameter (D₅₀) based on 50% of the particle diameter distribution in the measuring device.

In some embodiments, a thickness may be measured using a scanning electron microscope (SEM) or transmission electron microscope (TEM) image of a cross-section, but the present disclosure is not limited thereto and a thickness may be measured using any method used in the relevant field. The thickness may be an average thickness.

As used herein, soft carbon refers to a graphitizable carbon material that may be graphitized by heat treatment at high temperatures, for example 2800 °C. Hard carbon refers to non-graphitizable carbon material that is not graphitized by heat treatment. Soft carbon and hard carbon are well known in the art.

In some embodiments, crystalline carbon and amorphous carbon may be classified by X-ray diffraction analysis. The crystalline carbon includes natural graphite and artificial graphite. Here, natural graphite refers to naturally occurring graphite obtained by separation from minerals and having d002 of about 3.350 Å to about 3.360 Å as determined by X-ray diffraction analysis. Artificial graphite refers to graphite made by graphitization and having d002 of about 3.355 Å to about 3.365 Å as determined by X-ray diffraction analysis. The amorphous carbon has a d002 of less than or equal to about 3.34 Å when analyzed by X-ray diffraction. The X-ray diffraction analysis (XRD) uses CuKα ray as a target line and uses an X-ray diffraction analyzer, for example, X′Pert (by Malvern Panalytical). To improve peak intensity resolution, the monochromator equipment may be removed and measured. The measurement conditions may be 2θ=10° to 80°, scan speed (°/s)=0.044 to 0.089, and step size (°/step)=0.013 to 0.039.

Some embodiments provide a method of recovering lithium carbonate from a lithium-containing positive electrode active material washing liquid, and the method includes adding sodium carbonate to a lithium-containing positive electrode active material washing liquid to form first precipitation and filtering to obtain a first precipitate including lithium carbonate; adding phosphoric acid to the remaining washing liquid to form second precipitation and filtering to obtain a second precipitate including lithium phosphate; dissolving the second precipitate including the lithium phosphate in acid to obtain a lithium phosphate solution, adding a trivalent cation-containing compound to the lithium phosphate solution, and filtering to separate a product containing trivalent cation phosphate and a filtrate; and adding sodium carbonate to the filtrate to form a third precipitation to thereby obtain a third precipitate including lithium carbonate.

In the method of recovering lithium carbonate according to some embodiments, lithium carbonate is recovered first, then lithium phosphate is recovered second, and then lithium carbonate is formed from the lithium phosphate, thereby recovering lithium carbonate in its entirety. The lithium carbonate may be recovered from the washing liquid at a recovery rate of greater than or equal to about 88%.

Hereinafter, a method of recovering lithium carbonate according to embodiments is described in detail.

### Step 1) Step of Obtaining First Precipitate Including Lithium Carbonate

Sodium carbonate is added to a lithium-containing positive electrode active material washing liquid to form a first precipitation, and the resulting solution is filtered to obtain a first precipitate including lithium carbonate.

The lithium positive electrode active material washing liquid may be wastewater obtained, for example, in a process of removing residual Li from the positive electrode active material by water washing. A positive electrode active material such as a lithium transition metal oxide positive electrode active material may have an excess of residual Li. A high-nickel positive electrode active material may have a Ni content of greater than or equal to about 80 mol % based on 100 mol % of a metal included in the positive electrode active material excluding lithium and have an excess of residual Li. Because of this residual Li, if such batteries are exposed to high temperatures, they may react with the electrolyte to generate a large amount of gas, which may cause problems such as reduced thermal stability. Thus, water washing is performed to remove Li. And lithium therefore exists in the washing liquid, which is the wastewater after the washing.

The lithium-containing positive electrode active material may be represented by Chemical Formula 1.

LiₐNiₓCo_{y}A_{z}O₂ [Chemical Formula 1]

In Chemical Formula 1, 0.9≤a≤1.1, 0.8≤x≤0.98, 0.1≤y≤0.3, 0.1≤z≤0.3, x+y+z=1, and A is Mn or Al.

An amount of added sodium carbonate may be about 1 equivalent to about 10 equivalents, about 1 equivalent to about 5 equivalents, or about 1 equivalent to about 3 equivalents, based on 1 equivalent of lithium included in the lithium-containing positive electrode active material washing liquid. If the added amount of sodium carbonate is within these ranges, Li in the washing liquid may be better precipitated.

The sodium carbonate may be added in liquid form. For example, the addition of sodium carbonate may be performed using a sodium carbonate liquid having a concentration of about 5 wt % to about 50 wt %, about 10 wt % to about 40 wt %, or about 20 wt % to about 30 wt %. If sodium carbonate is used in liquid form, there may be a faster precipitation reaction and continuous processing is facilitated as compared to using a solid form of sodium carbonate. In the sodium carbonate liquid, the solvent may be water, glycerol, an alkaline solution such as an aqueous NaOH solution, an aqueous KOH solution, or a combination thereof.

The first precipitation process may be carried out for about 0.5 hours to about 3 hours or about 1 hour to about 2 hours. The first precipitation process may be carried out at a temperature of about 25 °C to about 100 °C, for example, about 60 °C to about 90 °C. In addition, the first precipitation process may be performed by stirring at a speed of about 100 rpm to about 500 rpm or about 200 rpm to about 400 rpm. The stirring process may be performed using a magnetic stirrer or an impeller stirrer. If the first precipitation process is performed under the above conditions, lithium carbonate may be precipitated in an appropriate amount.

In some embodiments, micro-filtering the lithium-containing positive electrode active material washing liquid may be performed before the sodium carbonate is added. The micro-filtering process may be performed by pressure reduction filtration using about 0.5 μm to about 10 μm filter paper (filter paper having pore size of about 0.5 μm to about 10 μm).

In some embodiments, after the micro-filtering process, an evaporation-concentration process may be performed before the first precipitation. The evaporation-concentration process may be concentrate the washing liquid by about 2 times to about 10 times, and the evaporation-concentration process may also be carried out to concentrate it by about 2 times to about 5 times. The evaporation-concentration process may be carried out by heating under atmospheric or reduced pressure conditions to evaporate water. The heating conditions may be about 70 °C to about 200 °C. The pressures of normal pressure and reduced pressure may be adjusted to a pressure that may evaporate water. If the washing liquid is concentrated by about 2 to about 10 times, the concentration of Li in the washing liquid increases, which may increase the recovery rate.

In the first precipitation process, a first precipitate including lithium carbonate is formed, and the first precipitate is filtered to separate and obtain lithium carbonate, for example, solid lithium carbonate. The filtering process may be performed by pressure reduction filtration using about 0.5 μm to about 10 μm filter paper.

### Step 2) Step of Obtaining Second Precipitate

Next, a second precipitation process is performed where phosphoric acid is added to the remaining washing liquid obtained in the filtering process, and filtering is performed to obtain a second precipitate including lithium phosphate.

An amount of added phosphoric acid may be about 1 g/L to about 50 g/L, about 10 g/L to about 40 g/L, or about 20 g/L to about 30 g/L. That is, the added phosphoric acid may be about 1 g to about 50 g, about 10 g to about 40 g, or about 20 g to about 30 g per 1 L of the washing liquid. If the added amount of the phosphoric acid is within these ranges, lithium phosphate may be well precipitated.

In some embodiments, the process of adding the phosphoric acid, a pH adjusting agent may be added to the remaining washing liquid to maintain the pH at about 9 or higher, for example, about 9 to about 14. Because the solubility of lithium phosphate is low in alkaline conditions, the precipitation rate of Li may be increased by adjusting the pH. The pH adjusting agent may be, for example, alkali such as NaOH, KOH, Ca(OH)₂, and the like.

The pH adjusting agent may be used in the form of a solid or aqueous solution, and a concentration may be about 0.5 M to about 5 M, or about 1 M to about 3 M. The second precipitation process may be carried out for about 0.5 hours to about 3 hours or about 1 hour to about 2 hours, and may be carried out at a temperature of about 50 °C to about 100 °C, for example, about 60 °C to about 90 °C. In addition, the second precipitation process may be performed with stirring at a speed of about 100 rpm to about 500 rpm or about 200 rpm to about 400 rpm. The stirring process may be performed using a magnetic stirrer or an impeller stirrer. If the second precipitation process is performed under these conditions, lithium phosphate (second precipitate) may be precipitated in an appropriate amount.

The filtering process may obtain a second precipitate including lithium phosphate, for example, solid lithium phosphate. The filtering process may be performed by pressure reduction filtration using 0.5 μm to about 10 μm filter paper.

### Step 3) Step of Removing Trivalent Cation Phosphate

The obtained second precipitate including lithium phosphate is dissolved in acid. In this process, lithium phosphate may be dissolved in acid, converted into acid lithium, and phosphoric acid may be formed. As a result, an acid lithium solution may be obtained. The concentration of the acid may be about 1 M to about 10 M, about 2 M to about 8 M, or about 3 M to about 7 about M.

An amount of the acid used may be about 0.1 L to about 5 L, about 0.5 L to about 3 L, or about 0.5 L to about 2 L per 100 g of lithium phosphate. If the amount of acid used per 100 g of lithium phosphate is within these ranges, the amount of pH adjusting agent added may be reduced in the subsequent pH adjustment process. The acid may be sulfuric acid, hydrochloric acid, nitric acid, or a combination thereof.

The dissolution process may be carried out for about 0.5 to about 3 hours or about 1 to about 2 hours, and may be carried out at a temperature of about 50 °C to about 100 °C, for example, about 60 °C to about 90 °C. In addition, the dissolution process may be performed by stirring at a speed of about 100 rpm to about 500 rpm or about 200 rpm to about 400 rpm.

Next, a filtering process is performed to remove undissolved lithium phosphate, impurities, and the like. The filtering process may be performed by pressure reduction filtration using 0.5 μm to about 10 μm filter paper.

A trivalent cation-containing compound is added to the acid lithium solution. The trivalent cation may be Fe, Al, Cr or a combination thereof. In some embodiments, the trivalent cation compound may be Fe₂(SO₄)₃, Al₂(SO₄)₃, Cr₂(SO₄)₃, or a combination thereof.

By adding the trivalent cation-containing compound, the phosphate ion (PO₄³⁻) included in the lithium solution is separated and bonded with the trivalent cation, forming a bonded product of the phosphate ion and the trivalent cation.

As such, the phosphate ion may be separated by precipitation. In this way, if the phosphate ion is separated and removed, the formation of impurities, such as Li₃PO₄, may be suppressed even if the pH increases to about 10 during the subsequent carbonation process.

An added amount of the trivalent cation-containing compound may be about 1 equivalent to about 5 equivalents, about 1 equivalent to about 3 equivalents, or about 1 equivalent to about 2 equivalents based on 1 equivalent of phosphoric acid included in the acid lithium solution. If the amount of the trivalent cation-containing compound is within these ranges, phosphate ion in the solution may be effectively removed.

Next, a pH adjusting agent is added to the mixture to adjust the pH to about 2 to about 7, or about 3 to about 5. Depending on the pH adjustment, the P present in the lithium phosphate solution, i.e., the phosphate ion (PO₄³⁻), and the cation in the trivalent cation compound may react to form a trivalent cation phosphate.

As the pH adjusting agent, an alkali such as NaOH, KOH, Ca(OH)₂, and the like may be used.

In one example, if sulfuric acid is used as the acid in dissolving the obtained second precipitate including lithium phosphate in the acid, and if Fe₂(SO₄)₃ is used as the trivalent cation-containing compound in the adding of the trivalent cation-containing compound, it may react as shown in Reaction Scheme 1 and Reaction Scheme 2.

2Li₃PO₄(s)+3H₂SO₄(aq)→3Li₂SO₄(aq)+2H₃PO₄(aq) [Reaction Scheme 1]

3Li₂SO₄(aq)+2H₃PO₄(aq)+Fe₂(SO₄)₃(aq)→2FePO₄(s)+6Li₂SO₄(aq) [Reaction Scheme 2]

A compound obtained by using the trivalent cation-containing compound, in which a trivalent cation and a phosphate ion are bonded such as FePO₄, may be treated with a base such as NaOH to provide, such as Fe(OH)₃, as in Reaction Scheme 3, and the main reaction is shown in Reaction Scheme 4. If the obtained Fe(OH)₃ is dissolved in sulfuric acid, as shown in Reaction Scheme 5 below, a trivalent cation compound, Fe₂(SO₄)₃, is obtained and may be reused with no waste being generated.

FePO₄(s)+NaOH(aq)→Fe(OH)₃(s)+Na₃PO₄(aq) [Reaction Scheme 3]

Fe³⁺(aq)+3OH⁻(aq)→Fe(OH)₃(s) [Reaction Scheme 4]

2Fe(OH)₃(s)+3H₂SO₄(aq)→Fe₂(SO₄)₃(aq)+6H₂O(aq) [Reaction Scheme 5]

If a calcium compound such as CaO, Ca(OH)₂, and the like are used instead of trivalent cation-containing compound for phosphate ion removal separation and pH adjustment, solid Ca₅(PO₄)₃OH with a low solubility of 0.3 mg/mL in water is formed, which is difficult to reuse and may generate a large amount of waste.

Next, the obtained resultant is filtered to separate the trivalent cation phosphate and the filtrate, thereby removing the trivalent cation phosphate and obtaining the filtrate. The filtering process may be performed, for example, as a filtering process under reduced pressure.

### Step 4) Step of Obtaining Third Precipitate

By adding sodium carbonate to the filtrate and performing a third precipitation, a third precipitate including lithium carbonate may be obtained. An added amount of sodium carbonate may be about 2 equivalents to about 8 equivalents, or about 2 equivalents to about 6 equivalents, per 1 equivalent of lithium. If the added amount of sodium carbonate is within these ranges, lithium carbonate may be well precipitated.

The third precipitation process may be carried out for about 0.5 hours to about 3 hours or about 1 hour to about 2 hours, and may be carried out at a temperature of about 50 °C to about 100 °C, for example, about 60 °C to about 90 °C. In addition, the third precipitation process may be performed by stirring at a speed of about 100 rpm to about 500 rpm or about 200 rpm to about 400 rpm. The stirring process may be performed using a magnetic stirrer or an impeller stirrer.

Before adding the sodium carbonate, a process of adding a pH adjuster to the obtained filtrate to adjust the pH to about 5 to about 14, for example, about 7 to about 12, may be performed. By this process, lithium carbonate formation may occur more effectively by adding sodium carbonate. As the pH adjusting agent, an alkali such as NaOH, KOH, Ca(OH)₂, and the like may be used.

Additionally, after adjusting the pH and before adding the sodium carbonate, a process of obtaining a filtrate by filtration under reduced pressure may performed. By this process, impurities may be removed before lithium carbonate precipitation so that high-purity lithium carbonate may be obtained.

In this way, the method of recovering lithium carbonate of the present disclosure may recover lithium carbonate in multiple stages from the first precipitate and the third precipitate in the lithium-containing positive electrode active material washing liquid. Thus, lithium can be obtained from a washing liquid with a recovery rate of greater than or equal to about 90%. The lithium may be obtained with a high recovery rate from the lithium-containing positive electrode active material washing liquid, which is waste. Thus, the process is economical and the recovered lithium carbonate may be used in the positive electrode active material preparing process. The process for preparing the positive electrode active material may be a method generally known in the art.

Examples and comparative examples of the present disclosure are described below. However, the following examples are only examples, and the present disclosure is not limited to the following examples.

### Comparative Example 1

500 ml of a washing liquid obtained by washing a LiNi_{0.98}Co_{0.1}Mn_{0.1}O₂ positive electrode active material with water was microfiltered under reduced pressure using a 1 μm filter paper. The obtained washing liquid was evaporation-concentrated to a half by heating at 100 °C.

To the concentrated washing liquid, 2 equivalents of a Na₂CO₃ solution (solvent: water) at a concentration of 25 wt % relative to 1 equivalent of Li included in the washing liquid was added. The mixture was then stirred by using a magnetic stirrer at 300 rpm at 80 °C to perform a precipitation process. A product obtained from the precipitation process was filtered under reduced pressure by using a 1 μm filter paper to obtain precipitates including lithium carbonate. The remaining washing liquid after the filtering was measured with respect to a concentration.

### Example 1

### Step 1

500 ml of a washing liquid obtained by washing a LiNi_{0.98}Co_{0.1}Mn_{0.1}O₂ positive electrode active material with water was microfiltered under reduced pressure by using a 1 μm filter paper. The obtained washing liquid was evaporation-concentrated to a half by heating at 100 °C.

To the concentrated washing liquid, 2 equivalents of a Na₂CO₃ solution (solvent: water) at a concentration of 25 wt % relative to 1 equivalent of Li included in the washing liquid was added. The mixture is stirred by using a magnetic stirrer at 300 rpm at 80 °C to perform a first precipitation process. A product obtained from the first precipitation process was filtered under reduced pressure by using a 1 μm filter paper to obtain precipitates including a lithium carbonate. A concentration of the remaining washing liquid was measured after the filtering.

### Step 2

H₃PO₄(S) was added to the remaining washing liquid from the filtering process and then, stirred at 300 rpm for 1 hour at 80 °C by using a magnetic stirrer to perform a second precipitation process. When the H₃PO₄ was added, 1 M NaOH was added to maintain pH at 10 to 11. An addition amount of the H₃PO₄ was 10 g per 1 L of the washing liquid.

A product obtained from the second precipitation process was filtered under reduced pressure by using a 1 μm filter paper to obtain second precipitates including lithium phosphate. The remaining washing liquid after the filtering was measured with respect to a concentration.

### Step 3

100 g of the lithium phosphate solid obtained from Step 2 was added to 1 L of 5 M H₂SO₄. The mixture was stirred at 300 rpm for 1 hour at 80 °C to carry out a dissolution reaction. In this process, the lithium phosphate was dissolved in sulfuric acid and converted to lithium sulfate while forming phosphoric acid. Thus, a lithium sulfate solution was obtained. The lithium sulfate solution was filtered under reduced pressure by using a 1 μm filter paper to remove undissolved lithium phosphate and impurities. A concentration of the filtrate remaining after the filtering was measured.

1 equivalent of Fe₂(SO₄)₃ relative to 1 equivalent of the phosphoric acid included in the lithium sulfate solution was added to the obtained lithium sulfate solution. The mixture was then stirred.

NaOH was added to the stirred product to adjust pH to 4. By this process, FePO₄ was formed and precipitated. The obtained product was filtered under reduced pressure by using a 1 μm filter paper to separate FePO₄ from a filtrate and remove the FePO₄.

### Step 4

NaOH was added to the filtrate obtained in Step 3 to make the pH 10. The mixture was filtered under reduced pressure by using a 1 μm filter paper to obtain a filtrate.

To the filtrate, 2 equivalents of a Na₂CO₃ solution (solvent: water) at a concentration of 25 wt % relative to 1 equivalent of Li included in the filtrate was added. The resultant was stirred by using a magnetic stirrer at 300 rpm for 1 hour at 80 °C to perform third precipitation, thereby obtaining third precipitates including lithium carbonate.

The lithium carbonate obtained in Step 1 and the lithium carbonate obtained in Step 4 were combined to obtain a total lithium carbonate.

### Example 2

Lithium carbonate was obtained in the same manner as in Example 1 except that 4 equivalents of Na₂CO₃ relative to 1 equivalent of Li included in the filtrate obtained in Step 3 was added to the filtrate obtained in Step 3.

### Example 3

Lithium carbonate was obtained in the same manner as in Example 1, except that in Step 2 the amount of H₃PO₄(S) was changed to 20 g/L relative to the washing liquid.

### Example 4

Lithium carbonate was obtained in the same manner as in Example 2, except that in Step 2 the amount of H₃PO₄(S) was changed to 20 g/L relative to the washing liquid.

A recovery rate of the lithium obtained in Step 4 according to Examples 1 to 4 was calculated according to Equation 1 below. The results are shown as an additional recovery rate in Table 1 below. In addition, each recovery rate of lithium obtained in Steps 1 and 4 of Examples 1 to 4 was calculated according to Equation 1 and then combined. The results are shown as a final recovery rate in Table 1. The obtained recovery rate is a recovery rate of lithium, which is the same as a recovery rate of lithium carbonate and, thus, expressed as a lithium carbonate recovery rate in Table 1.

Recovery rate of lithium carbonate=1−[(lithium concentration after precipitation*solution volume after precipitation)/(Li concentration before precipitation*solution volume before precipitation)] [Equation 1]

The recovery rate of lithium carbonate of Comparative Example 1 was also calculated by using Equation 1 and shown in Table 1.

TABLE 1

| | Additional | Final lithium carbonate |
|---|---|---|
| | recovery rate | recovery rate |
| Example 1 | 26% | 88% |
| Example 2 | 27% | 89% |
| Example 3 | 29% | 91% |
| Example 4 | 30% | 92% |
| Comparative Example 1 | — | 62% |

As shown in Table 1 Examples 1 to 4 exhibited very high lithium carbonate recovery rates of 88% to 92%. On the other hand, Comparative Example 1 exhibited a very low lithium carbonate recovery rate of 62%.

While this disclosure has been described in connection with what is presently considered to be practical example embodiments, it is to be understood that the disclosure is not limited to the disclosed embodiments. Rather, the present disclosure includes various modifications and equivalent arrangements.

What is claimed is:

1. A method of recovering lithium carbonate from a lithium-containing positive electrode active material washing liquid, the method comprising:
adding sodium carbonate to a lithium-containing positive electrode active material washing liquid to form a first precipitation and filtering to obtain a first precipitate including lithium carbonate;
adding phosphoric acid to the remaining washing liquid to form a second precipitation and filtering to obtain a second precipitate including lithium phosphate;
dissolving the second precipitate including the lithium phosphate in an acid to obtain an acid lithium solution, adding a trivalent cation-containing compound to the acid lithium solution, filtering to separate a trivalent cation phosphate and a filtrate, and removing the trivalent cation phosphate; and
adding sodium carbonate to the filtrate to form a third precipitation to thereby obtain a third precipitate including lithium carbonate.

2. The method as claimed in claim 1, wherein the lithium-containing positive electrode active material washing liquid is wastewater obtained by washing a positive electrode active material including a lithium transition metal oxide.

3. The method as claimed in claim 1, wherein the lithium-containing positive electrode active material includes nickel at an amount of greater than or equal to about 80 mol % based on 100 mol % of a total metal excluding lithium.

4. The method as claimed in claim 1, wherein before the first precipitation, the positive electrode active material washing liquid is micro-filtered.

5. The method as claimed in claim 4, wherein an evaporation-concentration is performed before the first precipitation and after the micro-filtering.

6. The method as claimed in claim 1, wherein an added amount of sodium carbonate is about 1 equivalent to about 10 equivalents based on 1 equivalent of lithium included in the lithium-containing positive electrode active material washing liquid.

7. The method as claimed in claim 1, wherein the sodium carbonate is added using a sodium carbonate solution having a concentration of about 5 wt % to about 50 wt %.

8. The method as claimed in claim 1, wherein an added amount of the phosphoric acid is about 1 g/L to about 50 g/L relative to remaining washing liquid.

9. The method as claimed in claim 1, wherein the acid to obtain the acid lithium solution is sulfuric acid, hydrochloric acid, nitric acid, or a combination thereof.

10. The method as claimed in claim 1, wherein a concentration of the acid to obtain the acid lithium solution is about 1 M to about 10 M.

11. The method as claimed in claim 1, wherein in the forming of the second precipitate, a pH adjusting agent is added to the remaining washing liquid to maintain the pH at about 9 or higher.

12. The method as claimed in claim 1, wherein an amount of the trivalent cation-containing compound is about 1 equivalent to about 5 equivalents based on 1 equivalent of phosphoric acid included in the acid lithium solution.

13. The method as claimed in claim 1, wherein the trivalent cation is Fe, Al, Cr, or a combination thereof.

14. The method as claimed in claim 1, wherein the trivalent cation-containing compound is Fe₂(SO₄)₃, Al₂(SO₄)₃, Cr₂(SO₄)₃, or a combination thereof.

15. The method as claimed in claim 1, wherein a recovery rate of lithium carbonate from lithium-containing positive electrode active material washing liquid is greater than or equal to about 88%.
